(19) United States
(12) Patent Application Publication
(10) Pub. No.: US 2015/0114933 A1
(43) Pub. Date: Apr. 30, 2015

(54) PUSHROD ASSEMBLY FOR A MEDIUM VOLTAGE VACUUM CIRCUIT BREAKER

(71) Applicant: ABB TECHNOLOGY AG, Zurich (CH)

(72) Inventors: Christian Reuber, Willich (DE); Phillip Masmeier, Dusseldorf (DE)

(21) Appl. No.: 14/590,313

(22) Filed: Jan. 6, 2015

Related U.S. Application Data
(63) Continuation of application No. PCT/EP2013/001967, filed on Jul. 4, 2013.

(30) Foreign Application Priority Data
Jul. 6, 2012 (EP) 12005016.6

(51) Int. Cl. H01H 33/666

(52) U.S. Cl. CPC H01H 33/666; H01H 2221/024
USPC 218/140

(57) ABSTRACT

A pushrod assembly for a medium voltage vacuum circuit breaker and vacuum circuit breaker are disclosed. The pushrod assembly can include a pushrod with an insulating body, whereby an electrical conducting terminal is arranged on a first abutting face of the insulating body and a guiding means is arranged on an opposing side of the electrical conducting terminal on a second abutting face of the insulating body for mechanically connecting the pushrod with an electromagnetic actuator. The pushrod can be integrated in the electromagnetic actuator and thus can be part of the electromagnetic actuator.

### RELATED APPLICATION(S)

This application claims priority as a continuation application under 35 U.S.C. §120 to PCT/EP2013/001967, which was filed as an International Application on Jul. 4, 2013, designating the U.S., and which claims priority to European Application 12005016.6 filed in Europe on Jul. 6, 2012. The entire contents of these applications are hereby incorporated by reference in their entireties.

### FIELD

The disclosure relates to a pushrod assembly for a medium voltage vacuum circuit breaker, which can include a pushrod with an insulating body and an insulating housing surrounding the pushrod, whereby an electrical conducting terminal is arranged on a first abutting face of the insulating body and a guide is arranged on an opposing side of the electrical conducting terminal on a second abutting face of the insulating body for mechanically connecting the pushrod with an electromagnetic actuator. The present disclosure also relates to a circuit breaker arrangement for medium voltage applications including at least one of such pushrod assemblies.

### BACKGROUND INFORMATION

A circuit breaker can include two electrical conducting terminals that are pushed onto each other for generating an electrical contact and that are moved away from each other for disconnecting the electrical contact. Thus, a circuit breaker can include a drive that is mechanically interconnected over a pushrod with one of the electrical conducting terminals that is adapted to transfer a movement of the drive onto the electrical conducting terminal.

As a rule, the end of the pushrod connected with the electrical conducting terminal of the circuit breaker can also be electrically connected to a medium or a higher voltage source. The other end of the pushrod can be grounded. Since in this case the two ends of the pushrod have to be insulated from each other, the pushrod can have an insulating body and can be accommodated in a housing that is filled with a fluid, for example, air, that can provide insulation between the two ends of the pushrod, to help avoid an external flashover.

Therefore, the two ends of the pushrod should have a certain minimal distance, such that the insulation requirements for the pushrod assembly including the pushrod and the housing are fulfilled. However, due to the minimal distance, the pushrod assembly can have a minimal size that cannot additionally be reduced.

Medium voltage circuit breakers according to the present disclosure are used for switching, for example, 1-72 kV of a high current level. These special circuit breakers can be used, for example, in electrical networks to interrupt short circuit currents as well as load currents under different load impedances. The number of switching poles can coincide with the number of phases in the electrical network. Mostly, a three pole arrangements is provided. Each switching pole can include vacuum or special gas filled interrupter inserts containing a pair of corresponding electrical contacts, wherein one of both contacts can be axial moveable arranged in order to form an electrical switch. The switching pole can interrupt the current by creating and extinguishing the arc in the closed vacuum or gas filled container. Modern vacuum circuit breakers tend to have a longer life expectancy than conventional air circuit breakers.

FR 2 850 204 A1 discloses an enclosed type switchgear in which vacuum valve provided with a pair of switching contacts and a moving mechanism part for moving the vacuum valve are disposed in a gas tank filled with insulating gas. One end of a moving current-carrying shaft can be integrally provided with a moving contact of the vacuum valve, and a contact pressure adjusting spring can be disposed on the other end of the moving current-carrying shaft. An operating rod can be disposed extending through the gas tank and the moving mechanism part can be mounted on the operating rod outside the gas tank. An insulating rod can be mounted inside the gas tank, and the contact pressure adjusting spring can be joined to the insulating rod. Thereby an oscillation amount of the moving current-carrying shaft and the moving contact of the vacuum valve can be minimized.

U.S. 2002/044403 A1 discloses a switching apparatus which can employ the interaction of magnetic fields produced by opposing coils having currents flowing through them to generate a drive force which can open and close electrodes to make or interrupt a circuit. The switching apparatus can include a switching portion having a fixed electrode and a movable electrode, which can be movable with respect to the fixed electrode between an open and a closed position to open and close the switch portion. A movable shaft can extend from the movable electrode. Furthermore, the switching apparatus can include an operating mechanism having a pair of fixed coils and a pair of movable coils. The movable coils can be operatively connected to the movable shaft for translating the movable shaft in its axial direction, whereby one of the pairs of coils being disposed between the other pair of coils. A controller controls a supply of current to the coils of the operating mechanism.

FR 2 815 463 A1 discloses a switchgear including a switch part composed of a stationary electrode and a movable electrode, a movable shaft extending from the movable electrode and an operating mechanism for opening and closing the switch part. The operating mechanism is equipped with a driving mechanism for driving the movable shaft, a holding mechanism for holding an opened or closed state and a reducing means for damping the shock attendant on a switching operation. A contact plate fixed to the movable shaft between a closing reduction damper and an opening reduction damper is moved upon closing and opening to contact with the respective reduction dampers, whereby the shock attendant on the switching operation can be damped to prevent part damage and switching operation failure.

U.S. Pat. No. 6,657,150 B1 discloses a shorting switch for eliminating arcing faults in power distribution equipment, whereby the shorting switch can include a vacuum switch having fixed and movable contact assemblies and a driven member. A spring cover tube and bushing mount the driven member for linear movement along a path substantially parallel to a longitudinal axis of the movable contact assembly. The driven member moves the movable contact assembly between open and closed circuit positions. A compression spring has a compressed state and a released state, which moves the driven member and movable contact assembly to the closed circuit position. A release bolt has an opening in the bolt and is coupled to the driven member to maintain the compression spring in the compressed state. A charge can be disposed in the opening of the release bolt and can be actuated to fracture the released state. First and second terminals can be respectively electrically interconnected with the fixed and movable contact assemblies.

### SUMMARY

A pushrod assembly is disclosed for a medium voltage vacuum circuit breaker, the assembly comprising: a pushrod with an insulating body; and an electrical conducting terminal arranged on a first abutting face of the insulating body and a guiding means arranged on an opposing side of the electrical conducting terminal on a second abutting face of the insulating body for mechanically connecting the pushrod with an electromagnetic actuator; wherein the pushrod is integrated in the electromagnetic actuator as part of the electromagnetic actuator.

A medium voltage vacuum circuit breaker is disclosed, the circuit breaker comprising: a vacuum switching chamber wherein two electrical conducting terminals are arranged; and a pushrod assembly, the pushrod assembly including: a pushrod with an insulating body; and an electrical conducting terminal arranged on a first abutting face of the insulating body and a guiding means arranged on an opposing side of the electrical conducting terminal on a second abutting face of the insulating body for mechanically connecting the pushrod with an electromagnetic actuator; wherein the pushrod is integrated in the electromagnetic actuator as part of the electromagnetic actuator; and whereby the pushrod assembly is arranged to move one of the electrical conducting terminals of the vacuum switching chamber.

### BRIEF DESCRIPTION OF THE DRAWINGS

Features of the present disclosure are explained below with reference to the exemplary embodiments shown in the drawings. In the drawings:

FIG. 1 shows a schematic medium voltage vacuum circuit breaker according to an exemplary embodiment of the disclosure;

FIG. 2 shows a schematic longitudinal cut through a pushrod assembly according to known pushrod assemblies;

FIG. 3 shows a schematic longitudinal cut through a pushrod assembly according to an exemplary embodiment of the disclosure; and

FIG. 4 shows a schematic longitudinal cut through an exemplary pushrod assembly according to an exemplary embodiment of the disclosure.

The reference symbols used in the drawings, and their meanings, are listed in summary form in the list of reference symbols.

### DETAILED DESCRIPTION

In accordance with an exemplary embodiment, a pushrod assembly with reduced size is disclosed, which can reduce the amount of material and the costs of a circuit breaker.

In accordance with an exemplary embodiment, a pushrod assembly for an electrical circuit breaker is disclosed. For example, the circuit breaker can be a medium voltage circuit breaker and/or a vacuum circuit breaker.

In accordance with an exemplary embodiment of the disclosure, the pushrod assembly can include a pushrod with an electrical insulating body. The pushrod assembly can include an insulating housing that surrounds the pushrod in a longitudinal direction of the pushrod assembly. The pushrod can be an elongated body that extends in the longitudinal direction of the pushrod assembly. Furthermore, the pushrod can be adapted to be moved within the insulating housing in the longitudinal direction.

In accordance with an exemplary embodiment of the disclosure, the pushrod can be integrated in the electromagnetic actuator and thus part of the electromagnetic actuator. For example, a guidance pin can be arranged on an abutting face of the insulating body for mechanically connecting the pushrod with the electromagnetic actuator. Furthermore, the guidance pin can be at least partially arranged inside the insulating body. For example, this arrangement can be realized by pressing the guidance pin in a blind hole of the insulating body. In accordance with an exemplary embodiment, the guidance pin can be screwed in a thread which can be arranged in the blind hole of the insulating body.

In accordance with an exemplary embodiment, the guidance pin can be molded or casted directly into the pushrod.

For example, guidance pin can represent the axis of the electromagnetic actuator. In this case, the pushrod can be directly connected to the electromagnetic actuator. Furthermore, an electrical conducting plate consisting of a metallic material can be arranged at an extent area of the insulating body. In addition, the electrical conducting plate can be electrically grounded.

Because of this arrangement, the overall length of the pushrod assembly can be reduced, such that a smaller circuit breaker can be designed that uses less material and can be produced at a lower cost.

In accordance with an exemplary embodiment, at least, for example, more than half of the extent area of the electrical conducting plate can be covered by the insulating body, which can be an improvement of the dielectric properties and can have an influence on the direct distance between the electrical conducting plate and the electrical conducting terminal.

In accordance with an exemplary embodiment, an integrated drive solution for a switch or circuit breaker is disclosed, where the space for a drive can be limited and the high voltage specifications can be fulfilled.

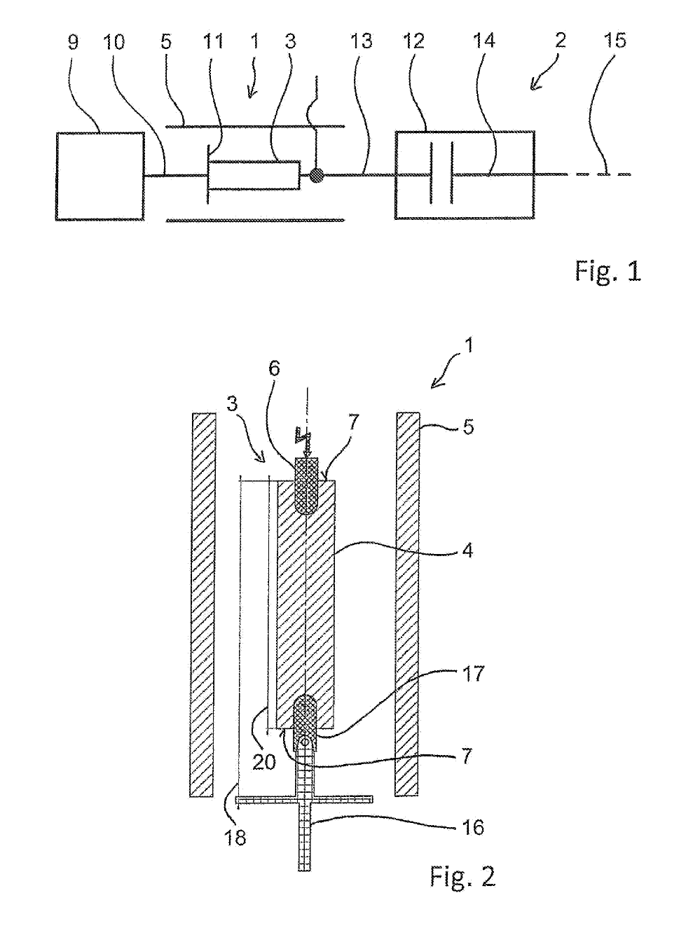

The medium voltage vacuum circuit breaker 2 according to an exemplary embodiment of the disclosure as shown in FIG. 1, can include a pushrod assembly 1, which is on the one side mechanically connected to an electromagnetic actuator 9 and on the other side mechanically connected to a vacuum switching chamber 12. The connection of the pushrod assembly 1 to the electromagnetic actuator 9 can include a guidance pin 10. The guidance pin 10 can be mechanically connecting a pushrod 3 of the pushrod assembly 1 with the electromagnetic actuator 9. The pushrod 3 can be surrounded by an insulating housing 5, which can also surround the switching chamber 12. The connection of the pushrod assembly 1 to the vacuum switching chamber can include a movable electrical conducting terminal 13. The pushrod 3 can be moved along an axis 15 to connect and disconnect the movable, electrical conducting terminal 13 to a non-movable electrical conducting terminal 14.

A pushrod assembly 1 according to the known art is shown in FIG. 2. The pushrod assembly 1 can include a movable pushrod 3 which includes an insulating body 4, an electrical conducting terminal 6 on a first abutting face 7, a grounded terminal 17 on a second abutting face 7 and a guiding connection 16 which can be arranged at the grounded terminal 17. Furthermore, the guiding connection 16 can be mounted on a drive which is not shown in this figure. The electrical conducting terminal 6 can be connected electrically and mechanically to a medium or high voltage interrupter. The pushrod 3 can be located within an insulating housing 5. The space between the pushrod 1 and the housing 5 can be filled with a gas or a liquid whose insulating properties are inferior to those of the insulating body 4. For example, the space between the pushrod 3 and the housing 5 can be filled with air.

FIG. 2 shows a separate design of the pushrod 3 and the connected drive, which can leads to a certain minimum length 18 of the pushrod assembly 1 to fulfill the dielectric specifications. For example, this minimum length 18 can be adverse for the design of medium voltage vacuum circuit breaker 2, following the tendency to reduce the size and the material of modern switchgear components. The pushrod assembly 1 can further include a contact pressure spring, which is not shown in the figures, as including or not including a contact pressure spring, which is not essential for the present exemplary embodiment.

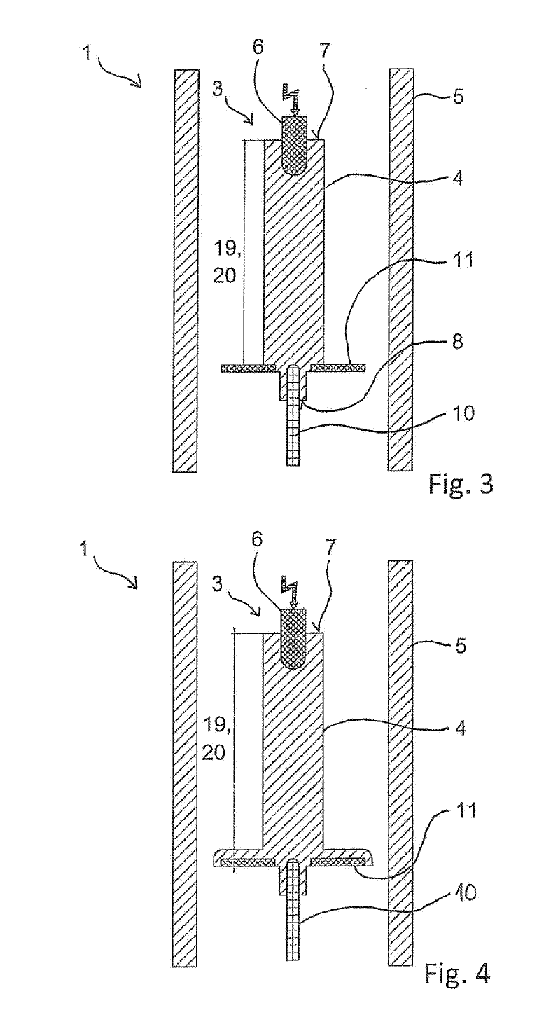

FIG. 3 shows a pushrod assembly 1 according to an exemplary embodiment of the disclosure of an integrated design of the pushrod 3, which allows the pushrod to fulfill functions of the drive itself. For example, the drive can be an electromagnetic actuator 9. The pushrod 3 can be integrated in the electromagnetic actuator 9 and thus part of the electromagnetic actuator 9. An electrical conducting terminal 6 can be arranged on a first abutting face 7. A guidance pin 10 can be arranged on the second abutting face 8 inside the insulating body 4 for mechanically connecting the pushrod 3 with the electromagnetic actuator 9. An electrical conducting plate 11 showing radial outward can be arranged at an extent area of the insulating body 4. The electrical conducting plate 11 can include a metallic material and can be electrically grounded. The guidance pin 10 of the pushrod 3 is not only a mechanical connection to the electromagnetic actuator 9 but can also be a part of the electromagnetic actuator 9, where the driving force can be applied. For example, the guidance pin 10 can be the axis of the electromagnetic actuator 9.

In accordance with an exemplary embodiment, the minimum length 18 of the pushrod assembly 1 in FIG. 2 can be decreased to a minimum length 19 in FIG. 3 without changing the direct distance 20 between the different electric potentials at the electrical conducting terminal 6 and the guiding connection 16 and respectively the electrical conducting plate 11, which can reduce the size of the pushrod assembly and the material used in construction of the pushrod assembly 1.

FIG. 4 shows an exemplary pushrod assembly 1 according to an exemplary embodiment of the disclosure, in which, for example, more than half of the extent area of the conducting plate 11 is covered by the insulating body 4, which can help improve the dielectric properties and can have an influence on the direct distance 20 between the conducting plate 11 and the electrical conducting terminal 6.

The disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art and practicing the claimed disclosure, from a study of the drawings, the disclosure, and the appended claims. For example, the conducting plate 11 can be a mechanical stop of the drive, or it can be an armature that is attracted by the electromagnetic actuator 9 to define and hold the OFF-position.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SIGNS

1 Pushrod assembly
2 Circuit breaker

### 3 Pushrod

4 Insulating body
5 Insulating housing

### 6 Terminal

7 First abutting face
8 Second abutting face
9 Electromagnetic actuator

### 10 Guidance pin

### 11 Plate

12 Switching chamber

### 13 Terminal

### 14 Terminal

### 15 Axis

16 Guiding connection

### 17 Terminal

18 Minimum length
19 Minimum length
20 Direct distance

What is claimed is:

1. A pushrod assembly for a medium voltage vacuum circuit breaker, the assembly comprising:
a pushrod with an insulating body; and
an electrical conducting terminal arranged on a first abutting face of the insulating body and a guiding means arranged on an opposing side of the electrical conducting terminal on a second abutting face of the insulating body for mechanically connecting the pushrod with an electromagnetic actuator;
wherein the pushrod is integrated in the electromagnetic actuator as part of the electromagnetic actuator.

2. The pushrod assembly of claim 1, comprising:
a guidance pin, which is arranged on the second abutting face of the insulating body for mechanically connecting the pushrod with the electromagnetic actuator.

3. The pushrod assembly of claim 2, wherein the guidance pin is at least partially arranged inside the insulating body.

4. The pushrod assembly of claim 2, wherein the guidance pin is an axis of the electromagnetic actuator.

5. The pushrod assembly of claim 3, wherein the guidance pin is an axis of the electromagnetic actuator.

6. The pushrod assembly of claim 1, comprising:
an electrical conducting plate, which is arranged radially outward of the insulating body.

7. The pushrod assembly of claim 6, wherein at least more than half of the electrical conducting plate is covered by the insulating body.

8. The pushrod assembly of claim 6, wherein the electrical conducting plate consists of a metallic material.

9. The pushrod assembly of claim 6, wherein the electrical conducting plate is electrically grounded.

10. A medium voltage vacuum circuit breaker, the circuit breaker comprising:
a vacuum switching chamber wherein two electrical conducting terminals are arranged; and
a pushrod assembly, the pushrod assembly including:
a pushrod with an insulating body; and
an electrical conducting terminal arranged on a first abutting face of the insulating body and a guiding means arranged on an opposing side of the electrical conducting terminal on a second abutting face of the insulating body for mechanically connecting the pushrod with an electromagnetic actuator;
wherein the pushrod is integrated in the electromagnetic actuator as part of the electromagnetic actuator; and
whereby the pushrod assembly is arranged to move one of the electrical conducting terminals of the vacuum switching chamber.

11. The circuit breaker of claim 10, comprising:
a guidance pin, which is arranged on the second abutting face of the insulating body for mechanically connecting the pushrod with the electromagnetic actuator.

12. The circuit breaker of claim 11, wherein the guidance pin is at least partially arranged inside the insulating body.

13. The circuit breaker of claim 11, wherein the guidance pin is an axis of the electromagnetic actuator.

14. The circuit breaker of claim 12, wherein the guidance pin is an axis of the electromagnetic actuator.

15. The circuit breaker of claim 10, comprising:
an electrical conducting plate, which is arranged radially outward of the insulating body.

16. The circuit breaker of claim 15, wherein at least more than half of the electrical conducting plate is covered by the insulating body.

17. The circuit breaker of claim 15, wherein the electrical conducting plate consists of a metallic material.

18. The circuit breaker of claim 15, wherein the electrical conducting plate is electrically grounded.
